(19) United States
(12) Patent Application Publication
(10) Pub. No.: US 2025/0117688 A1
(43) Pub. Date: Apr. 10, 2025

(54) BOOTSTRAPPED SIMULATED DATA FOR MODEL SIMULATION AND SELECTION

(71) Applicant: Capital One Services, LLC, McLean, VA (US)

(72) Inventors: Trijeet SETHI, McKinney, TX (US); Muralikumar VENKATASUBRAMANIAM, Plano, TX (US); Arunkumar RAJAPPAN, Plano, TX (US); Justin FLIETSTRA, The Colony, TX (US); Kunal CHUGH, Plano, TX (US); Jacky Huang Zheng KWOK, Allen, TX (US); Ralph DAVID, Flower Mound, TX (US)

(21) Appl. No.: 18/481,799

(22) Filed: Oct. 5, 2023

(51) Int. Cl. G06N 20/00

(52) U.S. Cl. CPC G06N 20/00

(57) ABSTRACT

In some implementations, a device may receive an input for a first prediction model. The device may execute, using the input, the first prediction model to generate a set of outputs, wherein the set of outputs is based on a set of inputs to a data processing pipeline associated with the first prediction model. The device may generate using a simulation engine and based on the set of outputs of the first prediction, a set of simulations of a set of results of implementing a set of actions associated with the first prediction model, wherein the set of simulations is associated with a simulated dataset representing a set of forecasts for simulating the set of results of implementing the set of actions. The device may output the simulated dataset to a model generation pipeline.

### BACKGROUND

Machine learning models can be used for performing determinations or predictions based on data generated by a monitored system. For example, a machine learning model can receive, as input, data identifying usage of a particular system and may generate, as output, a prediction of whether a security risk is detected in connection with the particular system. Training machine learning models using training data is a fundamental aspect of building prediction or determination systems. To train a machine learning model, an analysis system may obtain historical information (e.g., regarding the particular system for which predictions are to be performed) to facilitate the model's acquisition of patterns, relationships, and rules. By exposing the model to training data regarding a vast array of historical examples and scenarios, the analysis system can train the machine learning model with an inherent structure of the data, thereby enabling determinations or predictions using subsequent data.

During training, the analysis system adapts internal parameters of the machine learning model through iterative optimization techniques, adjusting a behavior of the machine learning model to optimize a difference between predicted outputs and actual outcomes in the training data. As a result, the machine learning model is trained to generalize from the training data and make accurate predictions or determinations as a response to new data that shares similar characteristics with the training data (e.g., a similar inherent structure). By leveraging the knowledge encoded within the training data, the machine learning model can provide valuable insights, assist in decision-making processes, and automate complex tasks across a wide range of domains.

### SUMMARY

Some implementations described herein relate to a system for model selection. The system may include one or more memories and one or more processors communicatively coupled to the one or more memories. The one or more processors may be configured to receive a set of outputs of a first prediction model, wherein the set of outputs is based on a set of inputs to a data processing pipeline associated with the first prediction model. The one or more processors may be configured to generate, using a simulation engine and based on the set of outputs of the first prediction, a set of simulations of a set of results of implementing a set of actions associated with the first prediction model, wherein the set of simulations is associated with a simulated dataset representing a set of forecasts for simulating the set of results of implementing the set of actions. The one or more processors may be configured to generate, using the simulated dataset, a set of second prediction models, wherein a second prediction model, of the set of second prediction models, estimates a set of features of the first prediction model using the simulated data. The one or more processors may be configured to aggregate the set of second prediction models into an aggregated model, wherein the aggregated model is configured to receive, based on an input to the set of second prediction models, an output from each second prediction model, of the set of second prediction models, and to generate an aggregated output. The one or more processors may be configured to deploy the aggregated model in the data processing pipeline to generate a set of new predictions based on a new set of inputs to the data processing pipeline.

Some implementations described herein relate to a non-transitory computer-readable medium that stores a set of instructions. The set of instructions, when executed by one or more processors of a system, may cause the system to receive a set of outputs of a first prediction model, wherein the set of outputs is based on a set of inputs to a data processing pipeline associated with the first prediction model. The set of instructions, when executed by one or more processors of the system, may cause the system to generate, using a simulation engine and based on the set of outputs of the first prediction, a set of simulations of a set of results of implementing a set of actions associated with the first prediction model, wherein the set of simulations is associated with a simulated dataset representing a set of forecasts for simulating the set of results of implementing the set of actions. The set of instructions, when executed by one or more processors of the system, may cause the system to generate, using the simulated dataset, a set of second prediction models, wherein a second prediction model, of the set of second prediction model estimates a set of features of the first prediction model using the simulated data. The set of instructions, when executed by one or more processors of the system, may cause the system to aggregate the set of second prediction models into an aggregated model. The set of instructions, when executed by one or more processors of the system, may cause the system to receive an input to the set of second prediction models. The set of instructions, when executed by one or more processors of the system, may cause the system to determine, based on an output from each second prediction model of the set of second prediction models, an aggregated output. The set of instructions, when executed by one or more processors of the system, may cause the system to perform an automated response action based on the aggregated output.

Some implementations described herein relate to a method for model selection. The method may include receiving, by a device, an input for a first prediction model. The method may include executing, by the device and using the input, the first prediction model to generate a set of outputs, wherein the set of outputs is based on a set of inputs to a data processing pipeline associated with the first prediction model. The method may include generating, by the device, using a simulation engine and based on the set of outputs of the first prediction, a set of simulations of a set of results of implementing a set of actions associated with the first prediction model, wherein the set of simulations is associated with a simulated dataset representing a set of forecasts for simulating the set of results of implementing the set of actions. The method may include outputting the simulated dataset to a model generation pipeline.

### BRIEF DESCRIPTION OF THE DRAWINGS

FIGS. 1A-1C are diagrams of an example associated with bootstrapped simulated data for model simulation and selection, in accordance with some embodiments of the present disclosure.

FIG. 2 is a diagram illustrating an example of training and using a machine learning model in connection with bootstrapped simulated data for model simulation and selection, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with bootstrapped simulated data for model simulation and selection, in accordance with some embodiments of the present disclosure.

FIG. 5 is a flowchart of an example process associated with bootstrapped simulated data for model simulation and selection, in accordance with some embodiments of the present disclosure.

### DETAILED DESCRIPTION

The following detailed description of example implementations refers to the accompanying drawings. The same reference numbers in different drawings may identify the same or similar elements.

Machine learning models can be deployed for generating predictions or performing determinations in a wide variety of fields. For example, in system security management, a machine learning model can predict whether usage of a system is associated with a security risk, such as a malicious actor accessing the system. Similarly, the machine learning model can determine whether to authenticate a user for access to one or more system functions based on analyzing user usage of the system. This may improve security for computing systems relative to static security techniques, such as the use of a user name and password to grant access to system functions.

Similarly, for transaction processing systems, a machine learning model can evaluate one or more factors associated with a transaction to determine whether to approve the transaction or to classify a request associated with the transaction. By improving transaction processing, the machine learning model reduces a risk of fraud, which may reduce a resource utilization associated with remediating the fraud. For example, by reducing a risk of fraudulently approving a transaction, the machine learning model reduces computing resources utilized in association with remediating damage fraudulently done to a user's credit profile (e.g., resources used to remove fraudulent transactions from a system). Similarly, by improving an accuracy of credit risk assessments, the machine learning model may reduce a frequency of credit appeals (e.g., to overturn a credit risk assessment), which may reduce a resource utilization associated with manually reviewing credit risk factors to evaluate a credit risk appeal.

An assessment system may train a machine learning model, using training data, before the machine learning model is deployed to generate predictions or perform determinations. For example, the assessment system may feed training data into the machine learning model and compare generated predictions to outcomes associated with the training data to optimize weights and relationships in the machine learning model, as described in more detail herein. However, when the machine learning model is trained and used to evaluate a particular set of inputs, the particular set of inputs may have a limited dataset, which may result in inaccurate predictions. For example, a prediction generated by the machine learning model may be limited to a narrow range of possible scenarios that can affect an accuracy of the prediction.

Some implementations described herein enable generation of bootstrapped simulation data for model simulation and selection. For example, the assessment system may generate a prediction using a machine learning model and may subject the prediction to a set of possible simulation scenarios to generate a set of forecasts. The assessment system may use data associated with the set of forecasts to generate a set of second models and may generate predictions using the set of second models. In this case, the assessment system may use a decision layer function to combine the generated prediction into a single prediction that is responsive to the original request. For example, the assessment system may generate a credit risk evaluation as a response to a request for a prediction of a credit risk. In this case, the assessment system may output the prediction and/or perform one or more automated actions based on the prediction. By generating bootstrapped simulation data, the assessment system improves prediction accuracy, thereby reducing resource utilization associated with actions taken as a result of predictions, as described above.

Additionally, or alternatively, in some cases, a decision engine may be configured to generate a decision based on one or more input values. However, when a subset of the input values are unknown, the decision engine may not be able to generate the decision. Accordingly, by generating bootstrapped simulation data, the assessment system can artificially generate a simulated input value for a decision engine, thereby enabling the decision engine to generate a decision in a scenario where an actual input value is unknown. In this way, the assessment system enables use of decision engines in scenarios with incomplete information, thereby improving systems that use decision engines for control of processes, procedures, or devices.

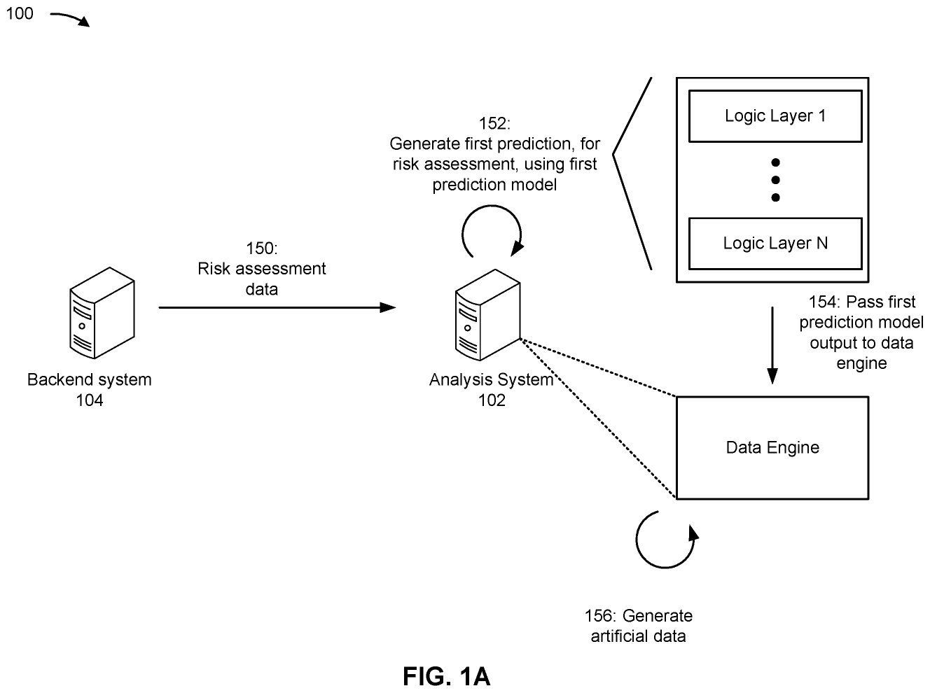

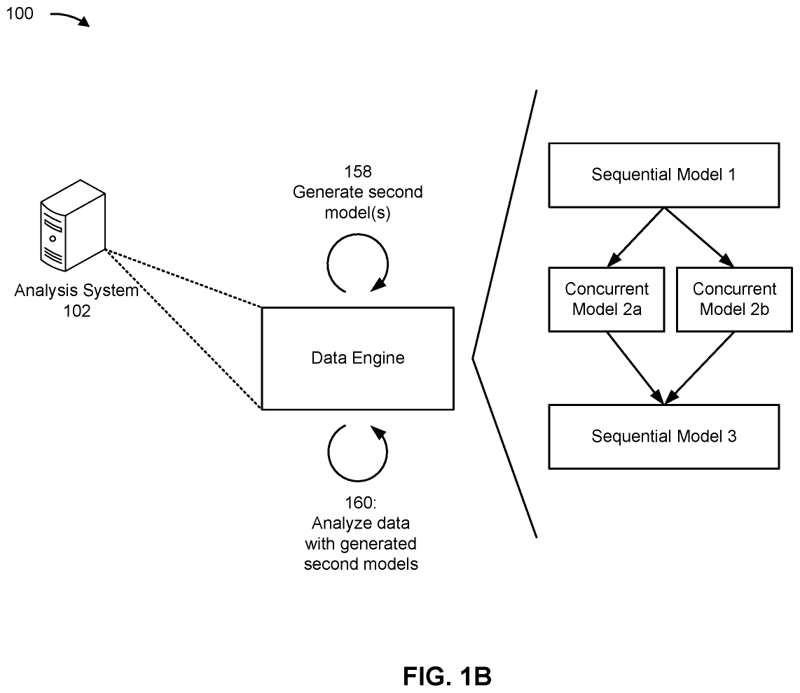

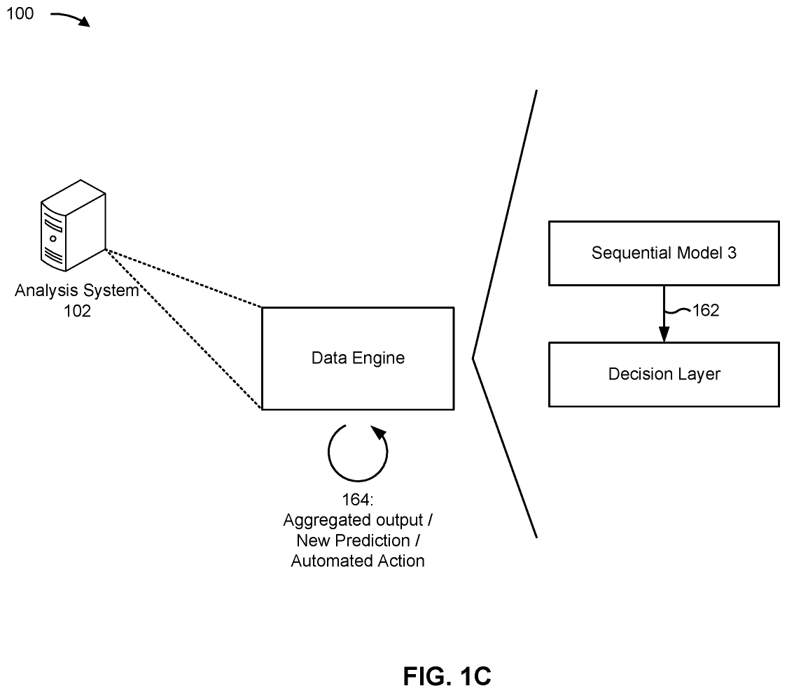

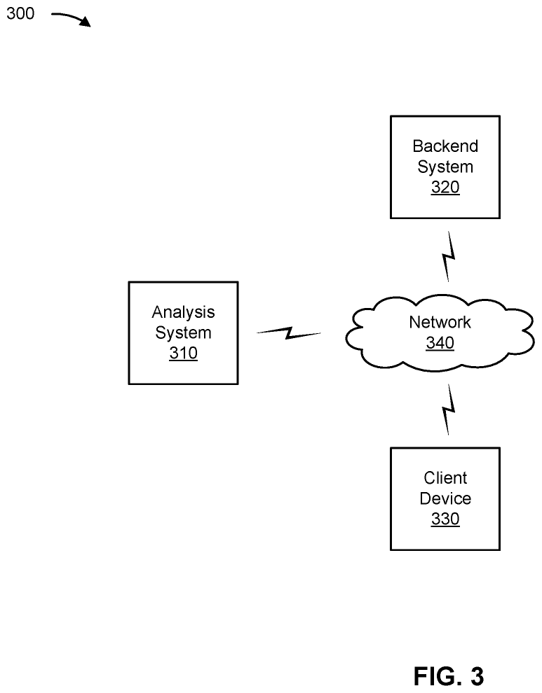

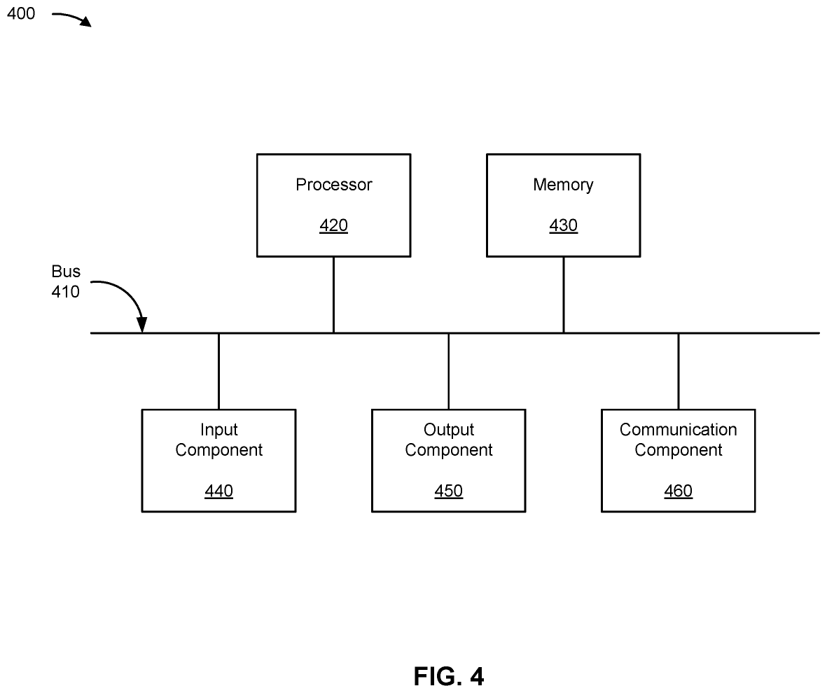

FIGS. 1A-1C are diagrams of an example 100 associated with bootstrapped simulated data for model simulation and selection. As shown in FIGS. 1A-1C, example 100 includes an analysis system 102 and a backend system 104. These devices are described in more detail in connection with FIGS. 3 and 4.

As shown in FIG. 1A, and by reference number 150, the analysis system 102 may receive risk assessment data. For example, the analysis system 102 may receive information identifying a set of inputs that can be used to perform a risk assessment. In some implementations, the risk assessment data may relate to a particular type of risk assessment. For example, the analysis system 102 may receive risk assessment data related to a credit risk. In this case, examples of risk assessment data that the analysis system 102 receives may include credit history data, income data, employment data, debt data, financial statement data, collateral data (e.g., data regarding a home for which a mortgage is being requested), loan data, market data, legal data (e.g., data regarding relevant laws, such as lending laws or collateral laws), and/or relationship data (e.g., data regarding prior relationships between a lender and a borrower). In another example, the analysis system 102 may receive risk assessment data related to another type of risk, such as security risk assessment data, fire risk assessment data, project risk assessment, health risk assessment data, or another type of risk assessment data.

As further shown in FIG. 1A, and by reference number 152, the analysis system 102 may generate a first prediction, for a risk assessment, using a first prediction model. For example, the analysis system 102 may use a first prediction model to generate a risk assessment based on the risk assessment data. In some implementations, the analysis system 102 may use a first type of prediction model as the first prediction model. For example, the analysis system 102 may use a machine learning model, as described in more detail herein, for the first prediction model. Additionally, or alternatively, the analysis system 102 may use an artificial intelligence model, a logic set, or a neural network model, among other examples for the first prediction model. In some implementations, the analysis system 102 may generate the first prediction for a particular type of risk assessment. For example, the analysis system 102 may generate a prediction of credit risk value, a loan approval determination, a determination of a credit score, a prediction of a range of values (e.g., a credit score range), an approval prediction (e.g., a prediction of whether a loan will be approved during a loan approval process), or another type of credit risk assessment. Additionally, or alternatively, the analysis system 102 may generate another type of risk assessment, such as a security risk assessment, a fire risk assessment, a project risk assessment, a health risk assessment, or another type of risk assessment.

As further shown in FIG. 1A, and by reference number 154, the analysis system 102 may pass the first prediction model output to a data engine. For example, the analysis system 102 may receive the first risk assessment (e.g., a determination of a credit risk value) at the data engine. In some implementations, the analysis system 102 may establish a connection between an output of the first prediction model and an input of the data engine. For example, a first prediction engine hosting the first prediction model may expose an application programming interface (API) to the analysis system 102 and the analysis system 102 may use the API to capture logs and outputs of the first prediction model and cause the logs and outputs of the first prediction model to be directed to a second module hosting the data engine (e.g., via an API of the second module).

As further shown in FIG. 1A, and by reference number 156, the analysis system 102 may generate artificial data. For example, the analysis system 102 may use the output of the first prediction model to generate the artificial data. In some implementations, the analysis system 102 may determine a set of forecast conditions for generating the artificial data. For example, the analysis system 102 may identify a set of scenarios (e.g., different changes to the risk assessment data, such as changes to macroeconomic conditions, changes to employment status, changes to home values, etc.) and may generate a set of forecasts for the set of scenarios. In this case, the analysis system 102 may capture data associated with each forecast, of the set of forecasts, to generate a new dataset for training machine learning models. For example, when simulating a change to macroeconomic conditions, the analysis system 102 may predict a change to an employment status, a salary status, a home value, etc., and may use the predicted changes to generate a new artificial dataset (e.g., a dataset with a new set of employment statuses, a new set of salary statuses, a new set of home values, etc.). In this case, the artificial dataset can be different from the risk assessment dataset because the risk assessment dataset is based on actual, measured, real-world conditions (e.g., a real-world employment status given a real world inflation rate), but the artificial dataset is based on simulated, predicted conditions (e.g., a predicted employment status given a simulated inflation rate). In some implementations, the analysis system 102 may generate the artificial dataset based on performing an unconstrained optimization procedure.

As shown in FIG. 1B, and by reference number 158, the analysis system 102 may generate a set of second prediction models. For example, the analysis system 102 may generate a set of second prediction models for generating a set of second predictions. In some implementations, the analysis system 102 may train the set of second prediction models using the artificial dataset. For example, the analysis system 102 may train the set of second prediction models to generate a set of second predictions relating to risk assessment (e.g., credit risk assessment) using the artificial dataset as a training dataset (e.g., rather than the risk assessment dataset used to perform a prediction and/or train the first prediction model). In some implementations, the analysis system 102 may use a bootstrapping technique to train the set of second prediction models. For example, the analysis system 102 may train the set of second prediction models to estimate one or more features of the first prediction model using the artificial data. In some implementations, the analysis system 102 may generate a set of sequential models. For example, the analysis system 102 may generate a first sequential model that generates a first set of outputs and a second sequential model that receives the first set of outputs as inputs and generates a second set of outputs. In this case, the second sequential model is executed, sequentially, after the first sequential model.

Additionally, or alternatively, the analysis system 102 may generate a set of concurrent models. For example, the analysis system 102 may generate a first model that receives a set of inputs and a second model that receives the same set of inputs. In this case, the first model and the second model are executed concurrently and each provide a set of outputs that are inputs to the same model (or models) at a next level. Additionally, or alternatively, the analysis system 102 may generate a combination of sequential and concurrent models. For example, as shown, the analysis system 102 may generate a first sequential model, a set of concurrent models (which, collectively, form a second sequential model), and a third sequential model, thereby generating a model pipeline for processing the artificial data. In some implementations, the analysis system 102 may connect the second prediction models via a streaming pipeline. For example, the analysis system 102 may use API calls or other uniform configuration interface linkages to control an interdependence of the second prediction models and associated new predicted features.

In some implementations, the analysis system 102 causes a second prediction model to repeatedly draw samples from the artificial data with replacement (e.g., to enable the same data point to be selected multiple times), which enables estimation of a population parameter (e.g., a feature of the first prediction model from which the artificial dataset was generated). In some implementations, the analysis system 102 may restrict a domain of the artificial data for a second prediction model. For example, the analysis system 102 may have different second prediction models with different domains within the artificial data. In this case, each second prediction model produces an output for each bootstrapped record generated in the generation of artificial data (e.g., from simulation of a set of forecasts). Accordingly, for an input data stream of artificial data of size n and a quantity of sequential model outputs m, a final output from the set of second prediction models is a predicted feature of size n×m. In this way, the analysis system 102 can generate a predicted feature of a size that grows exponentially in length with increasing quantities of sequential models.

As further shown in FIG. 1B, and by reference number 160, the analysis system 102 may analyze the risk assessment data using the set of second prediction models. For example, the analysis system 102 feeds the artificial data into the generated set of second prediction models and generates a set of outputs from the set of second prediction models. In this case, as described above, the set of outputs may include one or more predicted features of the first prediction model and/or one or more predictions relating to the risk assessment prediction from the first prediction model.

As shown in FIG. 1C, and by reference number 162, the analysis system 102 may pass an output from the set of second prediction models to a decision layer for aggregation. For example, the analysis system 102 may generate a decision layer model that aggregates n×m inputs (e.g., the predicted feature size that is a final output from the set of second prediction models) and may process the n×m inputs. In this case, the analysis system 102 reconciles differences in the bootstrapped artificial data across each of the second prediction models of the set of second prediction models, thereby enabling a determination that is based on a range of permutations of possible features for the first prediction model. As shown by reference number 164, the analysis system 102 may generate an aggregated output, provide a new prediction, or perform an automated action, among other examples. For example, the analysis system 102 may generate the determination as a single output, such as a new credit risk determination. In this case, by generating the new credit risk determination based on the range of permutations of forecasts associated with the artificial data, the analysis system 102 improves a prediction accuracy relative to the credit risk prediction of the first prediction model alone. By improving a prediction accuracy, the analysis system 102 reduces resource utilizations associated with inaccurate credit risk predictions (or other risk predictions), such as resource utilizations associated with manually remedying inaccurate credit risk predictions, as described above.

In some implementations, the analysis system 102 may output information associated with a new prediction. For example, the analysis system 102 may transmit an indicator of the new prediction for display via a client device. Additionally, or alternatively, the analysis system 102 may automatically perform an action associated with the new prediction. For example, the analysis system 102 may process a loan application or initiate a mortgage application based on the new prediction. Additionally, or alternatively, the analysis system 102 may process a transaction based on the new prediction (e.g., based on a prediction that there is not a security risk or fraud risk associated with the transaction).

In some implementations, the analysis system 102 may output information for processing using a decision engine. For example, when a decision engine is missing one or more input values (e.g., because the one or more input values are unknown), the analysis system 102 may generate a prediction of the one or more input values using the artificial data. In this case, the analysis system 102 provides the prediction of the one or more input values to the decision engine to enable the decision engine to be run and to generate a decision. Additionally, or alternatively, the decision engine may be incorporated into the analysis system 102. In this case, the analysis system 102 may execute the decision engine using one or more predicted or simulated values and may perform an action based on an output of the decision engine. For example, the analysis system 102 may use the decision engine to determine whether to approve a credit application or reject the credit application and may perform the approval or rejection based on a decision engine output. Additionally, or alternatively, the analysis system 102 may use a decision engine to determine one or more parameters for operating a device or controlling a process.

As indicated above, FIGS. 1A-1C are provided as an example. Other examples may differ from what is described with regard to FIGS. 1A-1C.

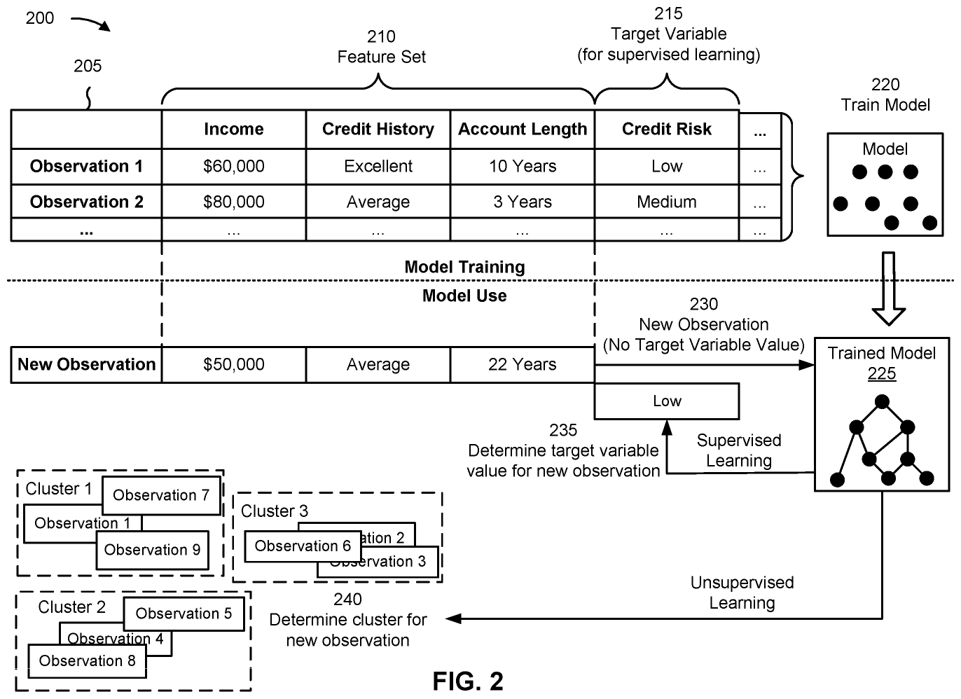

FIG. 2 is a diagram illustrating an example 200 of training and using a machine learning model in connection with bootstrapped simulated data for model simulation and selection. The machine learning model training and usage described herein may be performed using a machine learning system. The machine learning system may include or may be included in a computing device, a server, a cloud computing environment, or the like, such as the analysis system, described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the backend system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the backend system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an income level, a second feature of a credit history, a third feature of an account length, and so on. As shown, for a first observation, the first feature may have a value of “$60,000”, the second feature may have a value of “Excellent”, the third feature may have a value of “10 Years”, and so on. These features and feature values are provided as examples, and may differ in other examples. For example, the feature set may include one or more of the following features: debt-to-income ratio, credit utilization, length of credit history, type of debt, public record data, financial ratios, industry factors, economic factors, employment type, employment stability rating, or payment history, among other examples. Other feature sets are contemplated for other types of assessments.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is credit risk, which has a value of “low” for the first observation.

The feature set and target variable described above are provided as examples, and other examples may differ from what is described above. For example, for a target variable of network security risk, the feature set may include network usage amount, network usage pattern, network usage history, Internet Protocol (IP) address, medium access control (MAC) address, or device type, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, the machine learning system may train a decision tree algorithm to evaluate whether to approve a lending request based on a predicted credit risk. Additionally, or alternatively, the machine learning system may train a regression algorithm to determine a value for a credit risk. After training, the machine learning system may store the machine learning model as a trained machine learning model 225 to be used to analyze new observations.

As an example, the machine learning system may obtain training data for the set of observations based on receiving data from a backend system that processes transactions and/or stores user data relating to purchasing, debt, or income streams, among other examples. The machine learning system may use the training data to train a machine learning model to output a set of forecasts associated with a set of possible scenarios relating to a particular request. The machine learning system may generate bootstrapped simulation data from which the machine learning system may train a set of machine learning models to further evaluate the particular request. The machine learning system may output a predicted credit risk as a response to the particular request based on evaluating the particular request using the set of machine learning models trained with the bootstrapped simulation data, as described in more detail elsewhere herein.

As shown by reference number 230, the machine learning system may apply the trained machine learning model 225 to a new observation, such as by receiving a new observation and inputting the new observation to the trained machine learning model 225. As shown, the new observation may include a first feature of an income level, a second feature of a credit history, a third feature of an account length, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “Low” for the target variable of a credit risk for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, approving a credit request. The first automated action may include, for example, processing a transaction.

As another example, if the machine learning system were to predict a value of “High” for the target variable of a credit risk, then the machine learning system may provide a second (e.g., different) recommendation (e.g., rejecting a credit request) and/or may perform or cause performance of a second (e.g., different) automated action (e.g., rejecting a transaction).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., requests associated with a low level of credit risk), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., requests associated with a high level of credit risk), then the machine learning system may provide a second (e.g., different) recommendation (e.g., the second recommendation described above) and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include an outcome of a transaction or credit approval.

In this way, the machine learning system may apply a rigorous and automated process to risk assessment. The machine learning system may enable recognition and/or identification of tens, hundreds, thousands, or millions of features and/or feature values for tens, hundreds, thousands, or millions of observations, thereby increasing accuracy and consistency and reducing delay associated with manual evaluation of risk factors relative to requiring computing resources to be allocated for tens, hundreds, or thousands of operators to manually evaluate risk factors using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an analysis system 310, a backend system 320, a client device 330, and a network 340. Devices of environment 300 may interconnect via wired connections, wireless connections, or a combination of wired and wireless connections.

The analysis system 310 may include one or more devices capable of receiving, generating, storing, processing, providing, and/or routing information associated with generating bootstrapped simulated data for model simulation and selection, as described elsewhere herein. The analysis system 310 may include a communication device and/or a computing device. For example, the analysis system 310 may include a server, such as an application server, a client server, a web server, a database server, a host server, a proxy server, a virtual server (e.g., executing on computing hardware), or a server in a cloud computing system. In some implementations, the analysis system 310 may include computing hardware used in a cloud computing environment.

The backend system 320 may include one or more devices capable of processing, authorizing, and/or facilitating a transaction. For example, the backend system 320 may include one or more servers and/or computing hardware (e.g., in a cloud computing environment or separate from a cloud computing environment) configured to receive and/or store information associated with processing an electronic transaction. The backend system 320 may process a transaction, such as to approve (e.g., permit, authorize, or the like) or decline (e.g., reject, deny, or the like) the transaction and/or to complete the transaction if the transaction is approved. The backend system 320 may process the transaction based on information received from a transaction terminal, such as transaction data (e.g., information that identifies a transaction amount, a merchant, a time of a transaction, a location of the transaction, or the like), account information communicated to the transaction terminal by a transaction device (e.g., a transaction card, a mobile device executing a payment application, or the like) and/or information stored by the backend system 320 (e.g., for fraud detection).

The backend system 320 may be associated with a financial institution (e.g., a bank, a lender, a credit card company, or a credit union) and/or may be associated with a transaction card association that authorizes a transaction and/or facilitates a transfer of funds. For example, the backend system 320 may be associated with an issuing bank associated with the transaction device, an acquiring bank (or merchant bank) associated with the merchant and/or the transaction terminal, and/or a transaction card association associated with the transaction device. Based on receiving information associated with the transaction device from the transaction terminal, one or more devices of the backend system 320 may communicate to authorize a transaction and/or to transfer funds from an account associated with the transaction device to an account of an entity (e.g., a merchant) associated with the transaction terminal.

The client device 330 may include one or more devices capable of receiving, generating, storing, processing, and/or providing information associated with generating simulated data, as described elsewhere herein. For example, the client device 330 may initiate a credit check, which may result in the analysis system 310 generating simulated data and using the simulated data to predict a credit risk. The client device 330 may include a communication device and/or a computing device. For example, the client device 330 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with bootstrapped simulated data for model simulation and selection. The device 400 may correspond to analysis system 310, backend system 320, and/or client device 330. In some implementations, analysis system 310, backend system 320, and/or client device 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

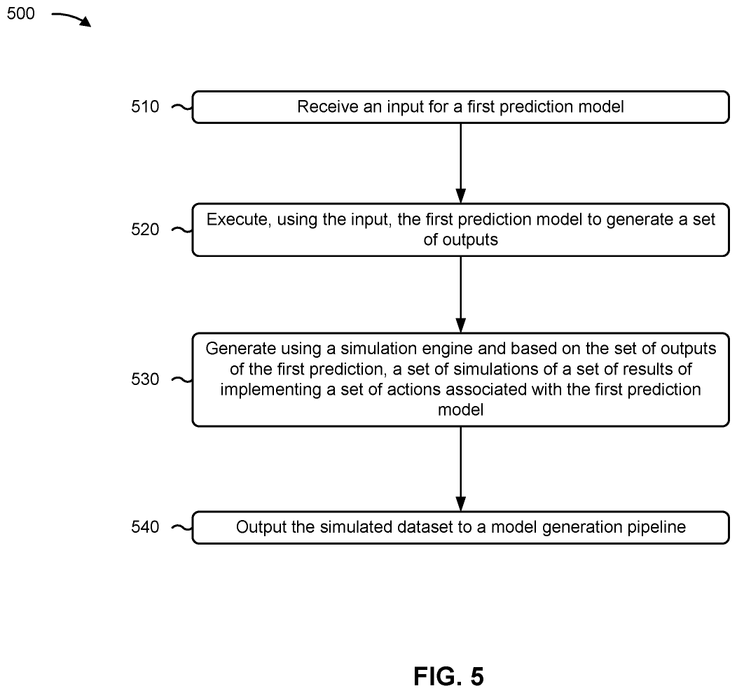

FIG. 5 is a flowchart of an example process 500 associated with bootstrapped simulated data for model simulation and selection. In some implementations, one or more process blocks of FIG. 5 may be performed by the analysis system 310. In some implementations, one or more process blocks of FIG. 5 may be performed by another device or a group of devices separate from or including the analysis system 310, such as the backend system 320 and/or the client device 330 Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving an input for a first prediction model (block 510). For example, the analysis system 310 (e.g., using processor 420, memory 430, input component 440, and/or communication component 460) may receive an input for a first prediction model, as described above in connection with reference number 150 of FIG. 1A. As an example, the analysis system 310 may receive risk assessment data identifying data regarding a risk, such as a security risk, a fraud risk, or a credit risk.

As further shown in FIG. 5, process 500 may include executing, using the input, the first prediction model to generate a set of outputs, wherein the set of outputs is based on a set of inputs to a data processing pipeline associated with the first prediction model (block 520). For example, the analysis system 310 (e.g., using processor 420 and/or memory 430) may execute, using the input, the first prediction model to generate a set of outputs, wherein the set of outputs is based on a set of inputs to a data processing pipeline associated with the first prediction model, as described above in connection with reference number 152 of FIG. 1A. As an example, the analysis system 310 may generate a set of logs and outputs relating to a security risk prediction, such as a credit risk prediction.

As further shown in FIG. 5, process 500 may include generating using a simulation engine and based on the set of outputs of the first prediction, a set of simulations of a set of results of implementing a set of actions associated with the first prediction model (block 530). For example, the analysis system 310 (e.g., using processor 420 and/or memory 430) may generate using a simulation engine and based on the set of outputs of the first prediction, a set of simulations of a set of results of implementing a set of actions associated with the first prediction model, as described above in connection with reference number 152 of FIG. 1A. As an example, the simulation engine, of the analysis system 310, may generate a set of predictions for different scenarios based on the logs and outputs of the security risk prediction. In this case, the simulation engine may predict, under a range of possible scenarios, whether the security risk prediction, such as a credit risk prediction, will be accurate and/or a level of accuracy of the security risk prediction. In some implementations, the set of simulations is associated with a simulated dataset representing a set of forecasts for simulating the set of results of implementing the set of actions.

As further shown in FIG. 5, process 500 may include outputting the simulated dataset to a model generation pipeline (block 540). For example, the analysis system 310 (e.g., using processor 420, memory 430, and/or output component 450) may output the simulated dataset to a model generation pipeline, as described above in connection with reference number 154 of FIG. 1A. As an example, the analysis system 310 may output a simulated dataset, associated with the set of simulations, such as a simulated dataset representing simulated risk assessment data that is predicted to be generated in connection with scenarios underlying the set of simulations. In some implementations, the analysis system 310 may use the simulated dataset to generate a second set of models, analyze data with the generated second set of models, and generate an aggregated output or new prediction based on analyzing the data with the generated second set of models. For example, the analysis system 310 may output a new security risk prediction, such as a new credit risk prediction, based on analyzing data using the generated second set of models.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for model selection, the system comprising:
one or more memories; and
one or more processors, communicatively coupled to the one or more memories, configured to:
receive a set of outputs of a first prediction model, wherein the set of outputs is based on a set of inputs to a data processing pipeline associated with the first prediction model;
generate, using a simulation engine and based on the set of outputs of the first prediction, a set of simulations of a set of results of implementing a set of actions associated with the first prediction model,
wherein the set of simulations is associated with a simulated dataset representing a set of forecasts for simulating the set of results of implementing the set of actions;
generate, using the simulated dataset, a set of second prediction models, wherein a second prediction model, of the set of second prediction models, estimates a set of features of the first prediction model using the simulated data;
aggregate the set of second prediction models into an aggregated model, wherein the aggregated model is configured to receive, based on an input to the set of second prediction models, an output from each second prediction model, of the set of second prediction models, and to generate an aggregated output; and
deploy the aggregated model in the data processing pipeline to generate a set of new predictions based on a new set of inputs to the data processing pipeline.

2. The system of claim 1, wherein the one or more processors are further configured to:
receive, via the data processing pipeline, the input;
execute the set of second prediction models, using the input, to generate the output from each second prediction model;
execute the aggregated model, using the output of each second prediction model;
generate a new prediction, of the set of new predictions, based on executing the aggregated model; and
output information associated with the new prediction.

3. The system of claim 2, wherein the one or more processors, to execute the aggregated model, are configured to:
reconcile bootstrapped artificial data across the set of second prediction models based on the output of each second prediction model.

4. The system of claim 2, wherein the new prediction is based on a range of permutations of possible features of the first prediction model.

5. The system of claim 1, wherein the one or more processors are further configured to:
perform one or more automated actions based on the set of new predictions.

6. The system of claim 1, wherein the first prediction model includes at least one of:
a machine learning model,
an artificial intelligence model,
a neural network model, or
a logic set.

7. The system of claim 1, wherein the set of second prediction models includes at least one of:
a pair of sequentially executed second prediction models, or
a pair of concurrently executed second prediction models.

8. The system of claim 1, wherein the aggregated model comprises a decision layer of the data processing pipeline.

9. The system of claim 1, wherein the set of new predictions includes at least one of:
a risk assessment prediction,
a range prediction, or
an approval prediction.

10. A non-transitory computer-readable medium storing a set of instructions, the set of instructions comprising:
one or more instructions that, when executed by one or more processors of a system, cause the system for model selection to:
receive a set of outputs of a first prediction model, wherein the set of outputs is based on a set of inputs to a data processing pipeline associated with the first prediction model;
generate, using a simulation engine and based on the set of outputs of the first prediction, a set of simulations of a set of results of implementing a set of actions associated with the first prediction model,
wherein the set of simulations is associated with a simulated dataset representing a set of forecasts for simulating the set of results of implementing the set of actions;
generate, using the simulated dataset, a set of second prediction models, wherein a second prediction model, of the set of second prediction model estimates a set of features of the first prediction model using the simulated data;
aggregate the set of second prediction models into an aggregated model;
receive an input to the set of second prediction models;
determine, based on an output from each second prediction model of the set of second prediction models, an aggregated output; and
perform an automated response action based on the aggregated output.

11. The non-transitory computer-readable medium of claim 10, wherein the first prediction model includes at least one of:
a machine learning model,
an artificial intelligence model,
a neural network model, or
a logic set.

12. The non-transitory computer-readable medium of claim 10, wherein the set of second prediction models includes at least one of:
a pair of sequentially executed second prediction models, or
a pair of concurrently executed second prediction models.

13. The non-transitory computer-readable medium of claim 10, wherein the aggregated model comprises a decision layer of the data processing pipeline.

14. The non-transitory computer-readable medium of claim 10, wherein the aggregated output is associated with at least one of:
a risk assessment prediction,
a range prediction, or
an approval prediction.

15. A method for model selection, comprising:
receiving, by a device, an input for a first prediction model;
executing, by the device and using the input, the first prediction model to generate a set of outputs, wherein the set of outputs is based on a set of inputs to a data processing pipeline associated with the first prediction model;
generating, by the device, using a simulation engine and based on the set of outputs of the first prediction, a set of simulations of a set of results of implementing a set of actions associated with the first prediction model,
wherein the set of simulations is associated with a simulated dataset representing a set of forecasts for simulating the set of results of implementing the set of actions; and outputting the simulated dataset to a model generation pipeline.

16. The method of claim 15, further comprising:
generating, using the simulated dataset, a set of second prediction models, wherein a second prediction model, of the set of second prediction models, estimates a set of features of the first prediction model using the simulated data;
aggregating the set of second prediction models into an aggregated model, wherein the aggregated model is configured to receive, based on an input to the set of second prediction models, an output from each second prediction model, of the set of second prediction models, and to generate an aggregated output; and
deploying, by the device, the aggregated model in the data processing pipeline to generate a set of new predictions based on a new set of inputs to the data processing pipeline.

17. The method of claim 16, further comprising:
receiving, via the data processing pipeline, the input;
executing the set of second prediction models, using the input, to generate the output of each second prediction model;
executing the aggregated model, using the output of each second prediction model;
generating a new prediction, of the set of new predictions, based on executing the aggregated model; and
outputting information associated with the new prediction.

18. The method of claim 17, wherein executing the aggregated model comprises:
reconciling bootstrapped artificial data across the set of second prediction models based on the output of each second prediction model.

19. The method of claim 17, wherein the new prediction is based on a range of permutations of possible features of the first prediction model.

20. The method of claim 16, further comprising:
performing one or more automated actions based on the set of new predictions.
